(19) United States
(12) Patent Application Publication
(10) Pub. No.: US 2007/0022227 A1
(43) Pub. Date: Jan. 25, 2007

(54) Path control device, system, cluster, cluster system, method and computer readable medium embodying program

(75) Inventor: Kenichi Miki, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/453,797

(22) Filed: Jun. 16, 2006

(30) Foreign Application Priority Data
Jul. 22, 2005 (JP) 2005-213468

(51) Int. Cl. G06F 3/00

(52) U.S. Cl. 710/38

(57) ABSTRACT

A path control device that controls first and second paths for accessing a peripheral subsystem, includes a command substituting unit that substitutes a first reserve command that allows an access through the first path, with a second reserve command that allows both of accesses through both of the first path and the second path.

### BACKGROUND OF THE INVENTION

The present invention relates to a path control device that controls a plurality of paths for accessing a peripheral subsystem (e.g., disk array subsystem).

As one example of a standard interface, an SCSI (small computer system interface) is a standard for connecting a compact computer, such as a personal computer, and a peripheral device, such as a hard disk or an optical disk device, and has been widely used. Any device that is connected to an SCSI bus constitutes a bidirectional fifty-fifty relationship, and may be an “initiator” and a “target”. The initiator is a device that issues a command on an SCSI bus, and a device that receives the command is the target. In most cases, the initiator may be an SCSI host adaptor (SCSI card), and the target may be an SCSI device (i.e., a disk controller). The SCSI device reads or writes data according to a read command or a write command from the initiator.

As a basic function of a path redundancy driver that conforms to the above SCSI, it has been known that a plurality of initiators (HBA: host bus adapter) are used. When a failure is detected at the time of I/O (Input/Output) with respect to a logical disk through a certain initiator, an I/O retry is conducted through another initiator (for example, JP-A No. 304331/2002). In addition, with the use of the plurality of initiators, there also exists a path redundant driver having a load dispersion function of the I/O path (effectively using a function of the I/O path band).

### SUMMARY OF THE INVENTION

However, when middleware or software use a “reserve” command, for example, a command of the SCSI with respect to an arbitrary logical disk, because the logical disk is occupied by the initiator that has issued the reserve command, it may be difficult to gain access (read data transfer I/O or write data transfer I/O) to the logical disk from another initiator. In other words, even if there exist a plurality of initiators (I/O paths) on the host computer, since the logical disk is occupied by the initiator that has issued the reserve command, it may be difficult to gain access from another initiator. Thus, the plurality of I/O path bands may not be effectively utilized. As one example using the reserve command, a cluster system has been known.

Hence, there exist many problems with the above described systems and apparatus including some exemplary problems discussed below.
(1) For example, as described above, even if the path redundancy driver has the load dispersion function of the I/O path, it may be difficult to positively utilize the load dispersion function of the I/O path with the use of the plurality of initiators.
(2) For example, after the release is implemented by the initiator that has already implemented the reserve (or reset by an arbitrary initiator), the reserve is conducted from another initiator, thereby making it possible to use the plurality of I/O paths. However, every time I/O is conducted, the following three I/O issuances may be required in total: (1) the release by the initiator that has implemented the reserve (or reset by an arbitrary initiator), (2) reserve by another initiator, and (3) intended I/O implementation. As a result, the I/O performance is adversely affected. Both of the “release” or “reset” are commands of the SCSI.
(3) Also, for example, the reserve state being temporarily released by the release command (or reset command) out of the control range of the middleware or software, may lead to the I/O access from an unintended initiator being enabled. Therefore, mismatching of the exclusive control or the data destruction (loss) of the logical disk may occur due to the middleware or software.

In view of the foregoing and other exemplary problems, drawbacks, and disadvantages of the conventional techniques, it is an exemplary feature of the present invention to provide a path control device, a system, a cluster, cluster system, a method and a computer readable medium embodying a program that is capable of positively utilizing the load dispersion function of the I/O path.

The present invention provides a path control device that controls first and second paths for accessing a peripheral subsystem, including a command substituting unit that substitutes a first reserve command that allows an access through the first path, by a second reserve command that allows accesses through both of the first path and the second path.

The present invention also provides a cluster, including host computers, each of the host computers including the path control device described above.

The present invention also provides a cluster system, including the cluster described above, the peripheral subsystem, and a switch that connects the one of the host computers to the peripheral subsystem with respect to the first path of the each host computer.

The present invention also provides a method of controlling first and second paths for accessing a peripheral subsystem, including substituting a first reserve command that allows an access through the first path by a second reserve command that allows accesses through both of the first path and the second path.

The present invention also provides a computer readable medium embodying a program, the program causing a path control device to perform the method described above.

For example, the present invention may allow accessing the peripheral subsystem through a plurality of paths. As a result, for example, the load dispersion function due to the plurality of paths may be sufficiently exercised.

For example, in the middleware or the software, since the reserve command may be issued as in the conventional art, a new modification may not be required. Accordingly, in the system environment where the middleware or the software uses the reserve, since the I/O path band nay be effectively utilized, the I/O access performance may be improved.

### BRIEF DESCRIPTION OF THE DRAWINGS

The novel and exemplary features believed characteristic of the invention are set forth in the appended claims. The invention itself, however, as well as other exemplary features and advantages thereof, will be best understood by reference to the detailed description which follows, read in conjunction with the accompanying drawings, wherein:

FIG. 1 is an exemplary block diagram showing path redundancy driver 4 according to an exemplary embodiment of the present invention;

FIG. 2 is an exemplary block diagram showing a system (e.g., disk array system 10) including path redundancy driver 4 according to this exemplary embodiment;

FIG. 3 is an exemplary block diagram showing cluster system 110 including path redundancy drivers 121, 122 according to this exemplary embodiment;

FIG. 4 is an exemplary flowchart showing an operation of path redundancy driver 4 according to this exemplary embodiment (flow 1);

FIG. 5 is an exemplary flowchart showing the operation of path redundancy driver 4 according to this exemplary embodiment (flow 2);

FIG. 6 is an exemplary flowchart showing the operation of path redundancy driver 4 according to this exemplary embodiment (flow 2);

FIGS. 7A and 7B are exemplary flowcharts showing the operation of path redundancy driver 4 according to this exemplary embodiment (flows 3 and 4);

FIG. 8 is an exemplary flowchart showing the operation of path redundancy driver 4 according to this exemplary embodiment (flow 5);

FIG. 9 is an exemplary flowchart showing the operation of path redundancy driver 4 according to this exemplary embodiment (flow 6); and

FIG. 10 is an exemplary flowchart showing the operation of path redundancy driver 4 according to this exemplary embodiment (flow 7).

### DETAILED DESCRIPTION OF THE EXEMPLARY EMBODIMENTS

The redundant path control device according to the present invention controls a plurality of paths for accessing a logical disk within a disk array subsystem. Then, according to the present invention, the redundant path control device includes: command acquiring means for acquiring a reserve instruction for reserving a first path in a plurality of paths; command substituting means for substituting a command that can permit not only an access from the first path but also an access from another path for the reserve command that is acquired by the command acquiring means; and command issuing means for issuing the command substituted by the command substituting means to the disk array subsystem. In the specification, “first path” may be a single path or a plurality of paths.

The reserve command permits an access to the logical disk from only one path. For that reason, up to now, when one path is reserved by a reserve command, other paths cannot access that logical disk. As a result, the load dispersion function due to the plurality of paths is not sufficiently exercised.

On the contrary, according to the present invention, the reserve command is not transmitted to the disk array subsystem as it is. Instead, the invention substitutes a command, that can permit an access from another path, for the reserve command and is then transmitted to the disk array subsystem. As a result, since the access from the plurality of paths can be conducted with respect to the logical disk, the load dispersion function due to the plurality of paths is sufficiently exercised. Also, since the reserve command is issued with respect to the middleware or the software upstream of the redundant path control device as in the conventional art, an additional change is not required. In other words, in the system environment in which the middleware or software uses the reserve, since means for effectively utilizing the I/O path band can be provided, the I/O access performance is improved.

In this situation, the command issued by the command issuing means may include information indicative of the first path. The disk array subsystem writes the information indicative of the first path into a register, thereby making it possible to permit an access to the logical disk from the first path. When the first path is made up of a plurality of paths, the information indicative of the first path is also information indicative of the plurality of paths. Likewise, the information on other paths is written into the register, thereby making it possible to permit the access to the logical disks from the plurality of paths.

The respective means may have the following functions. The command acquiring means may have a function for acquiring at least one command of a release command for releasing the reserve, a reset command for canceling the reserve, and a compulsory release command for compulsorily releasing the reserve in a second path that is reserved in the plurality of paths. The command substituting means may have a function of substituting a command that refuses an access from only the second path for the command that is acquired by the command acquiring means. The command issuing means has a function of issuing the command that is substituted by the command substituting means to the disk array subsystem. In the present specification, “second path” may be a single path or a plurality of paths. As a result, the access from only one path (i.e., the designated path) is refused by any one of the release command, the reset command, and the compulsory release command. In the middleware or the software upstream of the redundancy path control device, since the reserve command or the reset command may be issued as in the conventional art, no additional change is required.

In this situation, the command that has been issued by the command issuing means may include the information indicative of the second path. The disk array subsystem erases the information indicative of the second path from the register, thereby making it possible to refuse the access to the logical disk from the second path. Likewise, the disk array subsystem erases the information indicative of other paths from the register, thereby making it possible to refuse the access to the logical disk from the plurality of paths. When the second path includes a plurality of paths, the information indicative of the second path is also information indicative of the plurality of paths.

A disk array system according to the present invention includes the redundant path control device according to the present invention, and a disk array subsystem. The operation and effects of the disk array system according to the present invention are based on the operation and effects of the above-mentioned redundant path control device according to the present invention.

According to a redundant path control method of the present invention, in a method of controlling a plurality of paths for accessing a logical disk within a disk array subsystem, the method includes: acquiring a reserve command for reserving a first path in the plurality of paths; substituting a command that can permit not only an access from the first path but also an access from another path for the reserve command that is acquired by the command acquiring means; and issuing the command substituted by the command substituting means to the disk array subsystem. In this situation, the command that is issued to the disk array subsystem includes the information indicative of the first path, and the disk array subsystem writes the information indicative of the first path into a register upon receiving the issued command. Also, according to the present invention, the redundant path control method includes: acquiring at least one command including at least one release command for releasing the reserve, a reset command for canceling the reserve, and a compulsory release command for compulsorily releasing the reserve in a second path that is reserved in the plurality of paths; substituting a command that refuses an access from only the second path for the command that is acquired by the command acquiring means; and issuing the command that is substituted by the command substituting means to the disk array subsystem. In this situation, the command that is issued to the disk array subsystem includes the information indicative of the second path, and the disk array subsystem erases the information indicative of the second path from the register upon receiving the issued command. The operation and effects of the redundant path control method according to the present invention are based on the operation and effects of the above-mentioned redundant path control device according to the present invention.

According to the present invention, there is provided a redundant path control program used in a computer that functions as means for controlling a plurality of paths for accessing a logical disk within a disk array subsystem, and allows the computer to function as: command acquiring means for acquiring a reserve instruction for reserving a first path in a plurality of paths; command substituting means for substituting a command that can permit not only an access from the first path but also an access from another path for the reserve command that is acquired by the command acquiring means; and command issuing means for issuing the command substituted by the command substituting means to the disk array subsystem. The structural elements of the redundant path control program according to the present invention may correspond to the structural elements of the redundant path control device according to the present invention. Also, the operation and effects of the redundant path control program according to the present invention are based on the operation and effects of the above-mentioned redundant path control device according to the present invention.

In addition, the present invention may be structured as follows:
(1) A path redundancy driver including: means for acquiring a reserve command for reserving the disk array subsystem to that path; means for acquiring a release command for releasing the reserve state; means for acquiring a reset command for releasing the reserve state; means for acquiring a compulsory release command for compulsorily releasing the reserve state; and means for substituting another command for the acquired command to issue the another command to the disk array subsystem under the path redundancy driver.
(2) In the above item (1), the path redundancy driver issues a command which clears “information indicative of a state that permits an access from a path which constitutes a group” from the register when, instead of the acquired reserve command, “information indicative of a state that allows an access from not only a path to be accessed but also the path that constitutes the group” which is registered in a register for distinguishing the path to be accessed is issued to the disk array subsystem under the path redundancy driver, and the release command or the reset command is acquired.
(3) In the above items (1) and (2), the path redundancy driver has means that does not issue “information indicative of a state that permits an access from a path which is mounted in a host computer of the path redundancy driver” which is registered in a register that distinguishes the path to be accessed to the disk array subsystem under the path redundancy driver when a command for acquiring the reserve state of the disk array subsystem is issued to a disk device under the path redundancy driver, and the disk device is not reserved by the host computer.
(4) The path redundancy driver that is capable of accessing to the disk by dispersing from one host computer to a plurality of paths by the structure of the above items (1) to (3).
(5) A recording medium including the path redundancy driver having at least one of the functions of the above items (1) to (4).

Specific examples of the inventive structure will be described below. In the following example, it is assumed that there is used a disk array subsystem that loads a function for processing a persistent reserve-in command and a persistent reserve-out command in SCSI-3. Also, the following command functions (meanings) can be referred to from the following URL because of the specification of an SCSI.
http://www.t10.org/
http://www.t10.org/ftp/t10/drafts/spc2/spc2r20.pdf
http://www.t10.org/ftp/t10/drafts/spc3/spc3r23.pdf
<1>The path redundancy driver has means for acquiring the I/O request of the reserve.
<2>The path redundancy driver has means for acquiring the I/O request of the release.
<3>The path redundancy driver has means for acquiring the I/O request of the reset.
<4>The path redundancy driver has means for acquiring the I/O request that compulsorily releases the persistent reserve.
<5>The path redundancy driver has means for issuing and controlling a persistent reserve out—register service in an access permissible path.
<6>The path redundancy driver has means for substituting the persistent reserve out—reserve service for the service, and issuing the service to the disk array subsystem, and controlling the service in the I/O request of the reserve.
<7>The path redundancy driver has means for substituting the persistent reserve out—clear service for the service, and issuing the service to the disk array subsystem, and controlling the service in the I/O request of the release.
<8>The path redundancy driver has means for substituting the persistent reserve out—clear service for the service, and issuing the service to the disk array subsystem, and controlling the service in the I/O request of the reset.
<9>The path redundancy driver has means for issuing and controlling a persistent reserve in—read keys service and a persistent reserve in—read reservation service in order to acquire a state of the persistent reserve.
<10>The path redundancy driver has control means that does not use the persistent reserve out—register service when the persistent reserve is not conducted by the host computer of the path redundancy driver.
<11>The path redundancy driver has means for issuing and controlling the persistent reserve out—preempt service from an initiator, and moving the reserve due to the persistent reserve when a path failure is detected between another initiator that implements the reserve due to the persistent reserve and the disk array subsystem when the persistent reserve is conducted by the host computer of the path redundancy driver.
<12>The path redundancy driver has means for issuing and controlling the persistent reserve out—preempt service, and deleting registration information related to the persistent reserve when the persistent reserve is not any more used by the host computer of the path redundancy driver.
<13>The path redundancy driver has means for issuing and controlling a persistent reserve out—register and ignore existing key service in order to enable the persistent reserve command to be compulsorily used.
<14>The path redundancy driver has means for substituting the persistent reserve out—clear service for the service, and issuing and controlling the service to the disk array subsystem in the I/O request that compulsorily releases the persistent reserve.
<15>Means for issuing a persistent reserve compulsory release command is disposed on a user interface that operates the path redundancy driver.

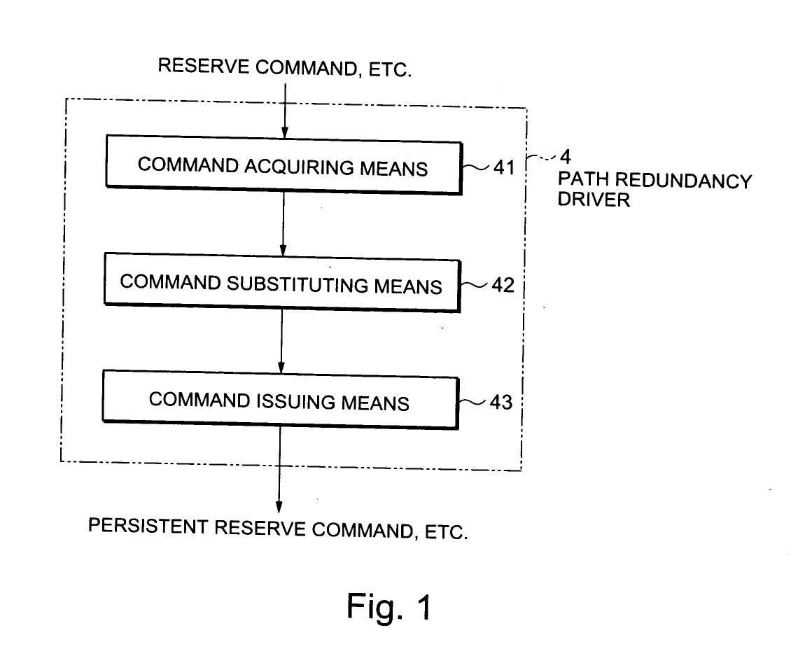

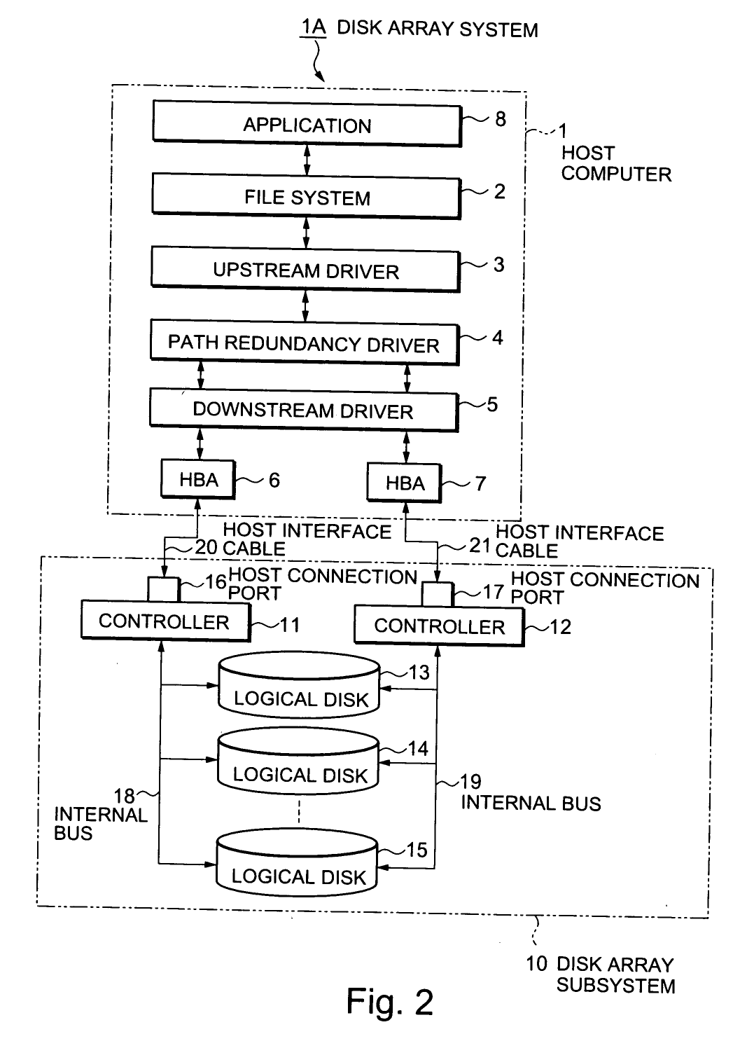

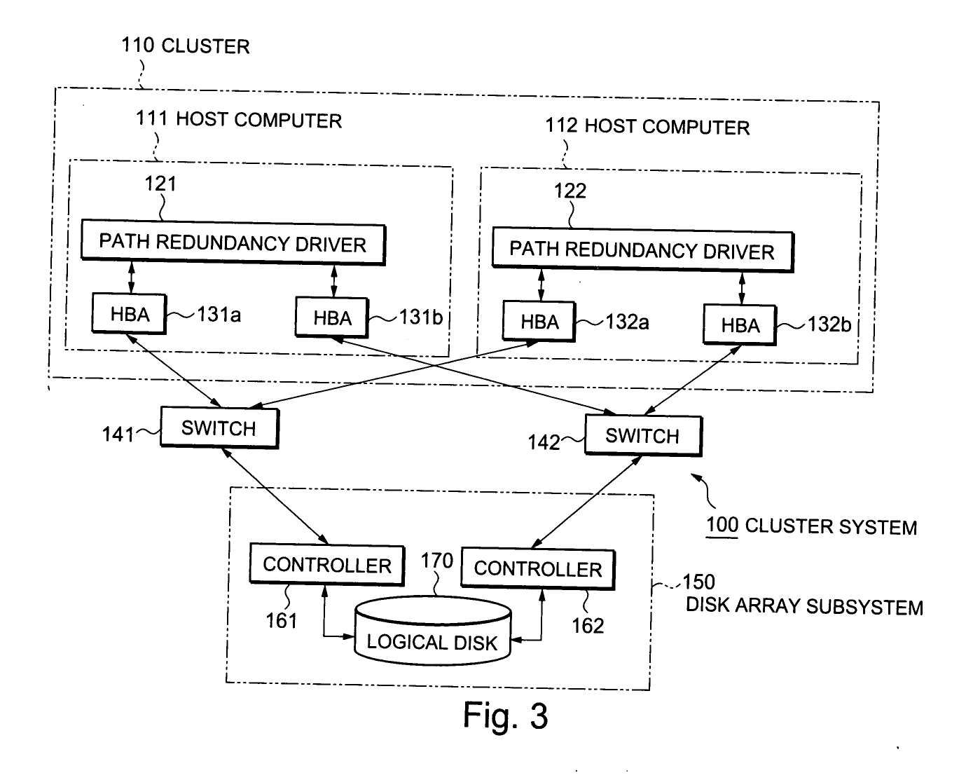

FIG. 1 is an exemplary block diagram showing path redundancy driver 4 (redundant path control device) according to an exemplary embodiment of the present invention. FIG. 2 is an exemplary block diagram showing a system (e.g., disk array system 1A) including the path redundancy driver 4 according to this exemplary embodiment. FIG. 3 is an exemplary block diagram showing cluster system 100 (e.g., disk array system) including a path redundancy driver 121, 122 according to this exemplary embodiment. Hereinafter, a description will be given of the exemplary embodiment with reference to those drawings.

Path redundancy driver 4 may include means (not shown) for controlling two paths (one path that passes through HBA 6 (see FIG. 2) and another path that passes through HBA 7, for accessing logical disks 13 to 15 within disk array subsystem 10, and also includes command acquiring means 41 (see FIG. 1), command substituting means 42, and command issuing means 43. Those means may be realized within host computer 1, for example, by a computer program (that is, one exemplary embodiment of the path redundancy program according to the present invention) or may be realized by hardware, or a combination of hard ware and software.

Command substituting means 41 acquires a reserve command for reserving one path. Command substituting means 42 substitutes a command that not only permits an access from one path, but also permits an access from another path for the reserve command that has been acquired by command acquiring means 41. Command issuing means 43 issues the command that has been substituted by command substituting means 42 to disk array subsystem 10.

The reserve command permits an access to logical disks 13 to 15 from only one path. For that reason, in the conventional system prior to the present invention, when one path is reserved by the reserve command, because logical disks 13 to 15 may not be accessed, the load dispersion function due to using a plurality of paths, is not sufficiently exercised.

On the contrary, in the invention, path redundancy driver 4 does not transmit the reserve command to disk array subsystem 10 as it is, but substitutes a command that can permit an access from other paths for the reserve command and can transmit the substitute command to disk array subsystem 10. Thus, gaining access to logical disks 13 to 15 may be made from the plurality of paths. As a result, the load dispersion function due to the plurality of paths potentially being utilized is sufficiently exercised. Also, since application 8 or the like, upstream of path redundancy driver 4, may issue the reserve command as in the conventional art, modification to the conventional systems, other than the provision of the invention path redundancy driver, is not required.

In this situation, the command that is issued by the command issuing means 43 includes information indicative of an access permissible path. Disk array subsystem 10 writes the information indicative of the path into a register, thereby permitting an access to logical disks 13 to 15 from that path. Likewise, the information indicative of other paths is also written into the register, thereby making it possible to permit an access to logical disks 13 to 15 from a plurality of paths. The register may be disposed, for example, within controllers 11 and 12, or within logical disks 13 to 15.

The respective means may include the following functions. For example, command acquiring means 41 has a function of acquiring at least one command including a release command for releasing the reserve, a reset command for canceling the reserve, and a compulsory release command for compulsorily releasing the reserve in one path which is reserved in a plurality of paths. Command substituting means 42 has a function of substituting a command that refuses (e.g., denies) an access from only one path for a command that has been acquired by command acquiring means 41. Command issuing means 43 has a function of issuing the command that has been substituted by command substituting means 42 to disk array subsystem 10.

As a result, an access from only the designated path may be refused by any one of the release command, the reset command, and the compulsory release command. Since application 8 or the like can issue the release command or the reset command as in the conventional art, a new modification to the conventional systems, other than providing the inventive path redundancy driver, is not required.

In this situation, the command that is issued by command issuing means 43 includes information indicative of an access refusal path. Disk array subsystem 10 erases the information indicative of the path from the register, thereby making it possible to deny an access to logical disks 13 to 15 from that path. Likewise, the information indicative of the other paths is also erased from the register, thereby making it possible to deny the accesses to logical disks 13 to 15 from the plurality of paths.

Subsequently, the exemplary structure of FIG. 2 will be described in more detail.

Disk array system 1A according to this exemplary embodiment may include host computer 1 and disk array subsystem 10. HBAs 6 and 7 of host computer 1 are connected to host connection ports 16 and 17 of controllers 11 and 12 in disk array subsystem 10 through host interface cables 20 and 21, respectively. Host computer 1 executes I/O with respect to logical disks 13 to 15 which are controlled by disk array subsystem 10. Downstream driver 5 controls HBAs 6 and 7 to conduct I/O processing.

Path redundancy driver 4 delivers I/O that has been received from upstream driver 3 to downstream driver 5. Also, path redundancy driver 4 may receive the execution result of I/O with respect to logical disks 13 to 15 which is controlled by disk array subsystem 10 through HBAs 6 and 7 from downstream driver 5, and conducts the determination of a normal completion or an abnormal completion. When it is determined that the abnormal completion is caused by a failure (trouble) of the structural elements of the path (HBAs 6, 7, host interface cables 20, 21, controllers 11, 12, and so on), the path redundancy driver 4 may conduct the retrial process of I/O which has been abnormally completed.

Controllers 11 and 12 in disk array subsystem 10 may be connected to logical disks 13 to 15 through internal buses 16 and 17, respectively. Both of controllers 11 and 12 may be capable of accessing respective logical disks 13 to 15.

Hereinbelow, a structure of FIG. 3 will be described.

Exemplary cluster system 100 of FIG. 3 is a two-node cluster system that uses the reserve with respect to logical disk 170, which includes two host computers I shown in FIG. 2, and one disk array subsystem 10 shown in FIG. 2 such that one disk array subsystem 10 is shared by two host computers 1.

For example, host computers 111 and 112 of FIG. 3 may be identical in the configuration with host computer 1 shown in FIG. 2 although being partially omitted from the drawing. Those host computers 111 and 112 constitute cluster 110. For example, disk array subsystem 150 shown in FIG. 3 may be identical in the configuration with disk array subsystem 10 shown in FIG. 2 although being partially omitted from the drawing. Host computer 111 may include path redundancy driver 121 and HBAs 131a, 131b, and host computer 112 may include path redundancy driver 122 and HBAs 132a, 132b. Disk array subsystem 150 may include controllers 161, 162, and logical disk 170. HBAs 131a, 132a, and controller 161 may be connected to each other through switch 141, and HBAs 131b, 132b, and controller 162 may be connected to each other through switch 142.

Subsequently, the operation disk array system 1A will be described with reference to FIG. 2.

Data (write data transfer I/O) that is written in disk array subsystem 10 by application 8 that operates on host computer 1 reaches control 11 through application 8, file system 2, upstream driver 3, path redundancy driver 4, downstream driver 5, HBA 6, host interface cable 20, and host connection port 16, and is then written in designated logical disks 13 to 15.

Data (read data transfer I/O) that is read from disk array subsystem 10 by application 8 that operates on host computer 1 reaches HBA 6 through controller 11, host connection port 16, and host interface cable 20 from designated logical disks 13 to 15, and further reaches application 8 through downstream driver 5, path redundancy driver 4, upstream driver 3, and a file system 2.

Also, the execution results of the respective I/O due to host computer 1 are judged by the respective layers of HBA 6, downstream driver 5, path redundancy driver 4, upstream driver 3, file system 2, and application 8, and some processing is conducted as required.

In this example, the path redundancy driver 4 is a driver that determines whether the execution result of the I/O which has been received from the downstream driver 5, is a “normal completion” or an “abnormal completion”. When it is determined that the abnormal completion is caused by a failure (trouble) of the structural elements of the path (HBA, interface cables, controllers etc.), path redundancy driver 4 conducts the retrial process of the I/O which has been abnormally completed. In addition, path redundancy driver 4 has a function of effectively utilizing a plurality of I/O paths so that I/O is not concentrated on only one I/O path (for example, controller 11), thereby to conduct the load dispersion of the I/O (sorts and routes the I/O into controllers 11 and 12).

Subsequently, means for effectively utilizing the I/O path band will be described when the middleware or the software uses the reserve.

First, exemplary problems with the conventional path redundancy driver under the environment using the reserve will be described.
(1) Even if the path redundancy driver has the load dispersion function of the I/O path, the load dispersion function of the I/O path with the use of a plurality of initiators (HBA) may not be positively utilized.
(2) After, for example, the release (or reset by an arbitrary initiator) is implemented by the initiator that has already implemented the reserve, the reserve is conducted from another initiator, thereby allowing use of the plurality of I/O paths. However, every time I/O is conducted, the following three I/O issuances may be required in total: (1) the release by the initiator that has implemented the reserve (or reset by an arbitrary initiator), (2) reserve by another initiator, and (3) intended I/O implementation. As a result, the I/O performance may be adversely affected.
(3) In the above item (2), because the reserve state is temporarily released by the release (or reset) out of the control range of the middleware or software, the I/O access from an unintended initiator may be enabled. Thus, the mismatching of the exclusive control or the data destruction (loss) of the logical disk due to the middleware or the software may arise.

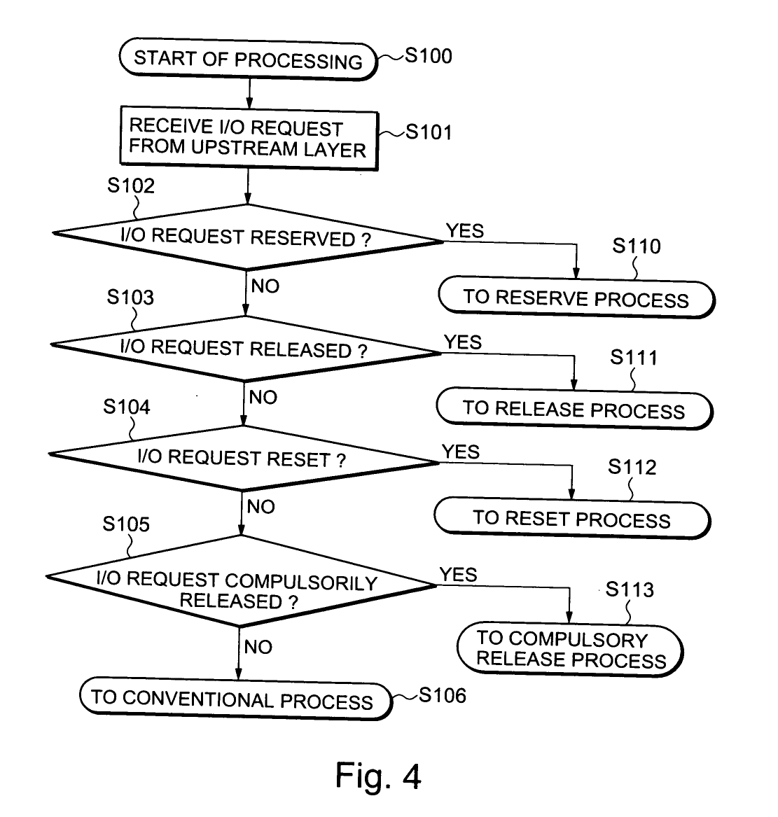

A method for solving the above problems will be described hereinafter with reference to FIGS. 2 and 4 to 10. FIGS. 4 to 10 are flowcharts showing a part of a procedure that is implemented by path redundancy driver 4 (the path redundancy method according to an exemplary embodiment of the present invention).

In this exemplary embodiment, a description will be given of a case using a disk device having a function of processing a persistent reserve-input (“reserve-in”) command and a persistent reserve-output (“reserve-out”) command in SCSI-3. Also, it is assumed that the reservation key that is used in the persistent reserve uses a unique value in each of the initiators that are mounted on one or a plurality of host computers. In the following description, as an example of the reservation key, there are used 8 bytes of the world-wide port name of an HBA which becomes an initiator. The world wide port name is an inherent identifier that is given the respective ports of a fiber channel device that connects a fiber channel cable.

FIG. 4 is an exemplary flowchart showing an I/O request discriminating process of path redundancy driver 4. Hereinafter, a description will be given mainly with reference to FIG. 4.

First, the I/O request is received from upstream driver 3 (Step S101), and it is determined whether the I/O request is the reserve, or not (Step S102). If the I/O request is the reserve (e.g., a “YES” in step S102), then the control is shifted to a reserve process (Step S110). If the I/O request is not the reserve (e.g., a “NO” in Step S102), it is determined whether the I/O request is the release, or not (Step S103).

When the I/O request is the release (e.g., a “YES” in Step S103), the control is shifted to the release process (Step S111). When the I/O request is not the release (e.g., a “NO” in Step S103), it is determined whether the I/O request is a reset, or not (Step S104).

When the I/O request is a reset (e.g., a “YES” in Step S104), the control is shifted to the reset process (Step S112). When the I/O request is not a reset (e.g., “NO” in Step S104), it is determined whether the I/O request is the compulsory release of the persistent reserve, or not (Step S105).

When the I/O request is the compulsory release of the persistent reserve (e.g., a “NO” in Step S105), the control is shifted to the compulsory release process (Step S113). When the I/O request is not the compulsory release of the persistent reserve, that is, when there is no correspondence of any one of Steps S102 to S105, the control is shifted to the process conducted in the conventional art (Step S106).

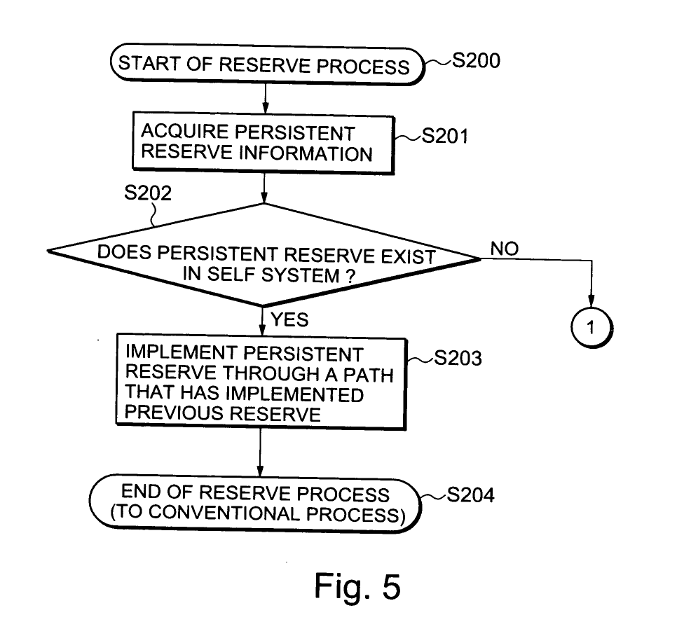

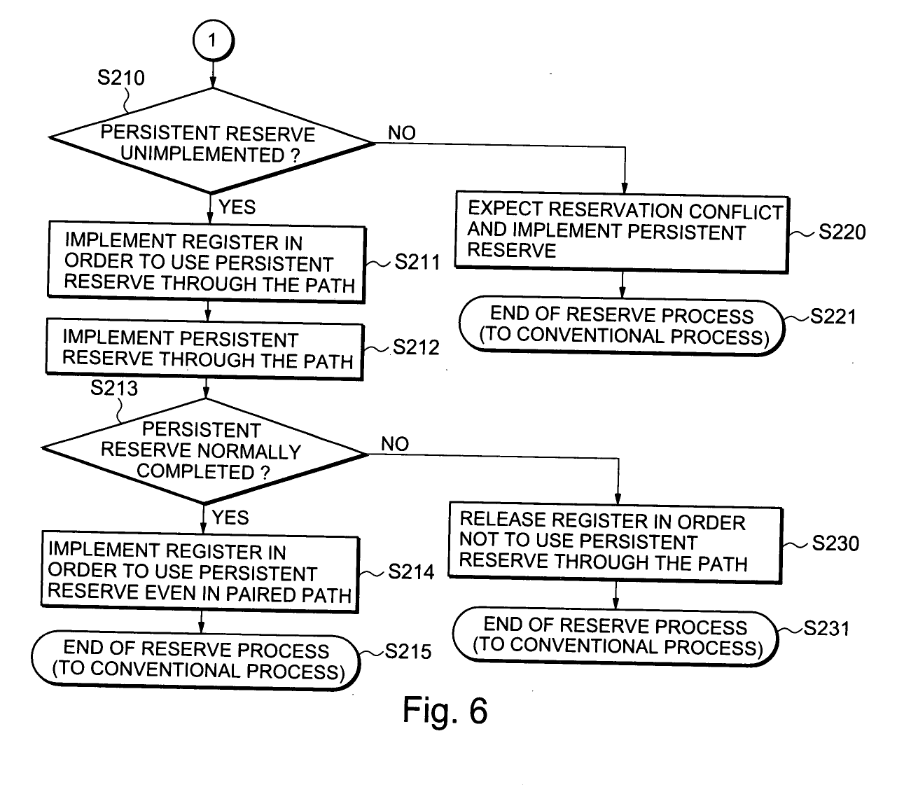

FIGS. 5 and 6 are exemplary flowcharts showing a conversion process for implementing the reserve due to the persistent reserve when the I/O request that has been received from upstream-n driver 3 is the reserve. Hereinafter, a description will be given mainly with reference to those drawings.

First, the I/O requests of the persistent reserve-in—read keys service and the persistent reserve-in—read reservation service are generated with respect to the persistent reserve information on intended logical disks 13 to 15 at that time, the I/O request is issued to downstream driver 5, and the information is acquired from disk array subsystem 10 (Step S201).

Subsequently, it is determined whether the persistent reserve is implemented by host computer 1 of path redundancy driver 4, or not, with reference to the information that has been acquired in Step S201 (Step S202). When the persistent reserve is implemented by host computer 1 of path redundancy driver 4, the control is shifted to Step S203. When the persistent reserve is not implemented by host computer 1 of path redundancy driver 4 (e.g., a “NO” in Step S202), the control is shifted to Step S210.

<<Process when the Persistent Reserve Has Been Already Implemented By the Host Computer of Path Redundancy Driver>>

In Step S203, in order to implement the reserve due to the persistent reserve with respect-to intended logical disks 13 to 15, it is specified whether the initiator that has already implemented the persistent reserve-out—reserve service is HBA 6 or HBA 7 of host computer 1 of the path redundancy driver with reference to the information that has been acquired in Step S201 (it is assumed that the initiator is HBA 6 in this exemplary embodiment), and 8 bytes of the world wide port name of HBA 6 are designated to the reservation key. Also, the I/O request of the persistent reserve-out—reserve service that designates exclusive access—registrants only to the type is generated, and then issued to downstream driver 5.

With the above operation, the processing in the case of implementing the reserve due to the persistent reserve by host computer 1 of the path redundancy driver is completed, and the control is shifted to the conventional process (Step S204).

<<Process When the Persistent Reserve is Unimplemented By the Host Computer of the Path Redundancy Driver>>

In Step S202, when the reserve due to the persistent reserve is unimplemented in host computer 1 of the path redundancy driver, it is determined whether the persistent reserve per se has been implemented, or not, with reference to the information that has been acquired in Step S201 (Step S201). When the persistent reserve per se due to the persistent reserve has not been implemented, the control is shifted to Step S211. When the reserve due to the persistent reserve has been implemented by a host computer (not shown in FIG. 2, refer to FIG. 3) which is not equipped in the path redundancy driver, the control is shifted to Step S220.

<<Process when the Persistent Reserve has been Already Implemented By a Host Computer Other than the Host Computer of the Path Redundancy Driver>>

When the control is shifted to Step S220, an expected value is that the reserve due to the persistent reserve has been already implemented by a host computer that is not equipped in the path redundancy driver, and the I/O request of the reserve which has been received from upstream driver 3 fails in the reserve in a reservation conflict response.

Eight bytes of the world wide port name of any HBA (HBA 6 in this exemplary embodiment) of HBA 6 and HBA 7 is designated as a reservation key with respect to intended logical disks 13 to 15. Also, the I/O request of the persistent reserve-out—reserve service which has designated the exclusive access—registrants only to the type is generated, and then issued to downstream driver 5.

In the above pattern, the I/O request of the persistent reserve-out—register service is not issued from any initiator of HBA 6 and HBA 7 of host computer of the path redundancy driver. As a result, the I/O request of the persistent reserve-out—reserve service which has been issued to downstream driver 5 fails in the reserve in the reservation conflict response, to thereby obtain an expected result.

<<Process when the Persistent Reserve is not Implemented By the Host Computer of the Path Redundancy Driver or Another Host Computer>>

In Step S211, because the reserve due to the persistent reserve is not implemented by any initiator of the host computer of the path redundancy driver or another host computer, in order to use the persistent reserve with respect to the intended logical disks, 8 bytes of the world wide port name of any HBA (HBA 6 in this exemplary embodiment) of HBA 6 and HBA 7 are designated as a service action reservation key. The I/O request of the persistent reserve-out—register service which designates zero as the reservation key is generated, and issued to downstream driver 5 (Step S212).

Subsequently, in order to implement the reserve due to the persistent reserve from HBA 6 with respect to intended logical disks 13 to 15, 8 bytes of the world wide port name are designated as the reservation key. Also, the I/O request of the persistent reserve-out—reserve service which has designated the exclusive access—registrants only as the type is generated, and then issued to downstream driver 5 (Step S212).

Then, in Step S213, the execution result of the reserve due to the persistent reserve which has been issued to downstream driver 5 in Step S212 is recognized, and when the execution result is the normal completion, the control is shifted to Step S214. When the execution result is the abnormal completion, the control is shifted to Step s230.

In Step S214, in order to use the persistent reserve with respect to intended logical disks 13 to 15 from HBA 7 which is paired with HBA 6, 8 bytes of the world wide port name of HBA 7 are designated as a service action reservation key. The I/O request of the persistent reserve-out—register service which designates zero as the reservation key is generated, and issued to downstream driver 5. Through the above processing, when the middleware or the software uses the reserve, the I/O access using a plurality of initiators is enabled.

With the above operation, the process when the reserve due to the persistent reserve is not implemented by the host computer of the path redundancy driver or another host computer is completed, and the control is shifted to the conventional process (Step S215).

<<Process when the Persistent Reserve cannot be Conducted because the Reserve or the Reset is Conducted By a Host Computer Other than the Computer of the Path Redundancy Driver>>

In Step S230, since the host computer of the path redundancy driver has already implemented the I/O request of the reserve or implemented the I/O request of the reset, the reserve due to the persistent reserve from HBA 6 could not be conducted. Therefore, the I/O request of the persistent reserve-out—preempt service which designates the reservation key related to HBA 6 is generated, and then issued to downstream driver 5. As a result, the deletion of the persistent reserve registration information related to HBA 6 with respect to the intended logical disk is implemented, and the persistent reserve from host computer 1 of the path redundancy driver is not used.

With the above operation, the process when the I/O request of the reserve or the I/O request of the reset is implemented by a host computer other than the host computer of the path redundancy driver is completed, and the control is shifted to the conventional process (Step S231).

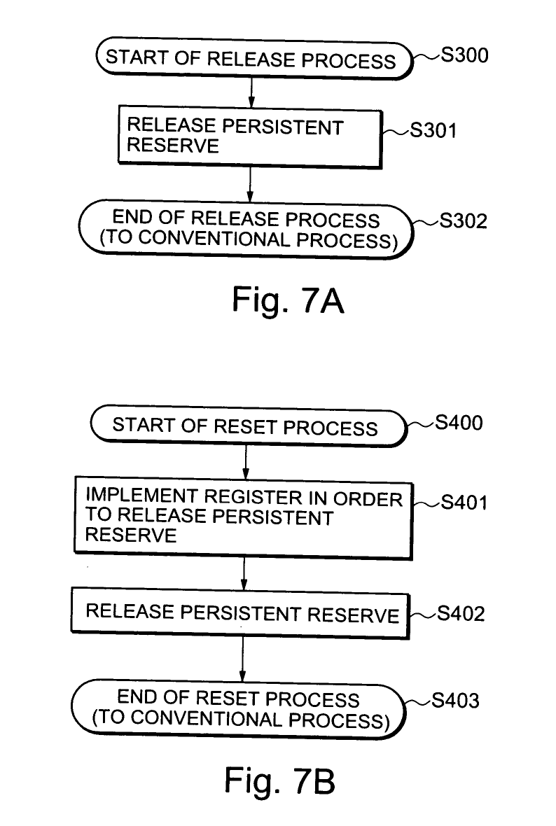

FIG. 7A is an exemplary flowchart showing a process for releasing a reserve relationship due to the persistent reserve when the I/O request that has been received from upstream driver 3 is the release. Hereinafter, a description will be given mainly with reference to that drawing.

This I/O request is issued from the initiator that has issued the reserve command, thereby making it possible to release the reserve of the logical disk which is reserved in the initiator. However, it is impossible to release the reserve of the logical disk which is reserved in another initiator. For that reason, in this exemplary embodiment, an attempt is made to only release all of the reserve relationships due to the persistent reserve-out—reserve service and the persistent reserve-out—register service, and whether the reserve relationships could be released or not, is not particularly minded.

In Step S301, the I/O request of the persistent reserve-out—clear service which designates 8 bytes of the world wide port name of any HBA (HBA 6 in this exemplary embodiment) of HBA 6 and HBA 7 as a reservation key is generated with respect to intended logical disks 13 to 15, and then issued to downstream driver 5.

With the above operation, the process when path redundancy driver 4 receives the I/O request of the release is completed and the control is shifted to the conventional process (Step S302).

Through the above processing, when the persistent reserve-out—register has been previously conducted with respect to intended logical disks 13 to 15 in host computer 1 of the path redundancy driver, it is possible to release all of the reserve relationships due to the persistent reserve-out—reserve service and the persistent reserve-out—register service with respect to the logical disks. When the persistent reserve-out—register has not been previously conducted with respect to the logical disks in host computer 1 of the path redundancy driver, it is impossible to release the reserve relationships due to the persistent reserve-out—reserve service and the persistent reserve-out—register service with respect to the logical disks, and the original action of the release command can be realized.

FIG. 7B is an exemplary flowchart showing a process for resetting the reserve due to the persistent reserve when the I/O request that has been received from upstream driver 3 is the reset. Hereinafter, a description will be given mainly with reference to that drawing.

This I/O request is not limited to the initiator that has issued the reserve command, but is capable of resetting the reserve of the logical disks that are reserved in an arbitrary initiator by issuing the reserve command from any initiator. For that reason, in this exemplary embodiment, all of the reserve relationships due to the persistent reserve-out—reserve service and the persistent reserve-out—register service with respect to the intended logical disks are reset.

In Step S401, the I/O request of the persistent reserve-out—register and ignore existing key service which designates 8 bytes of the world wide port name of any HBA (HBA 6 in this exemplary embodiment) of HBA 6 and HBA 7 as a reservation key is generated with respect to intended logical disks 13 to 17, and then issued to downstream driver 5.

Subsequently, in Step S402, the I/O request of the persistent reserve-out—clear service which designates, as the reservation key, 8 bytes of the world wide port name of HBA 6 which has issued the persistent reserve-out—register and ignore existing key service in Step S401 is generated with respect to intended logical disks 13 to 15, and then issued to downstream driver 5.

Through the above processing, it is possible to reset all of the reserve relationships due to the persistent reserve-out 0 reserve service and the persistent reserve-out—register service with respect to the intended logical disks regardless of whether the persistent reserve-out—register having been previously conducted on the logical disks, or not. Therefore, the original action of the reset command can be realized.

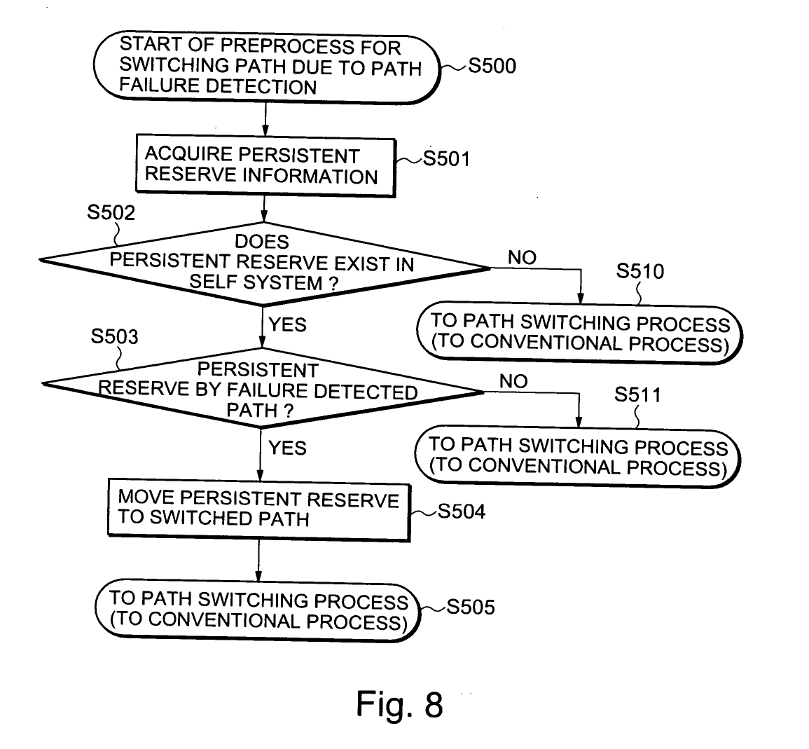

FIG. 8 is an exemplary flowchart showing a preprocess for retrying the I/O request by switching over the present path to another path by path redundancy driver 4 when a path failure is detected in the execution result of the I/O request with respect to an arbitrary logical disk that has been received from downstream driver 5. Hereinafter, a description will be given mainly with reference to that drawing.

First, with respect to the persistent reserve information related to the logical disks at the present moment, the I/O request of the persistent reserve in—read keys service and the persistent reserve in—read reservation service is generated and then issued to downstream driver 5, to thereby acquire information from the disk array subsystem 10 (Step S501).

In Step S502, it is determined whether the reserve due to the persistent reserve has been implemented by host computer 1 of the path redundancy driver, or not, with reference to the information that has been acquired in Step S501. When the reserve has been implemented by host computer 1 of the path redundancy driver, the control is shifted to Step S503, whereas when the reserve has not been implemented by host computer 1 of the path redundancy driver, the control is shifted to a conventional path switching process (Step S510).

In Step S503, it is determined whether the persistent reserve-out—reserve service has been implemented by the path from which the path failure has been detected, or not, with reference to the information that has been acquired in Step S501. When the persistent reserve-out—reserve service has been implemented by the path from which the path failure has been detected, the control is shifted to Step S505 whereas when the persistent reserve-out —reserve service has not been implemented by that path, the control is shifted to a conventional path switching process (Step S511).

In Step S504, the persistent reserve-out—reserve service has been implemented by the path from which the path failure has been detected (HBA 6 in this exemplary embodiment). As a result, the I/O request of the persistent reserve-out—preempt service which designates 8 bytes of the world wide port name of HBA 6 as the service action reservation key and designates 8 bytes of the world wide port name of HBA 7 as the reservation key due to a switched path (HBA 7 in this exemplary embodiment) is generated, and then issued to downstream driver 5. Through the above processing, the reserve due to the persistent reserve can be moved to the path of HBA 7.

With the above operation, the preprocess when the path redundancy driver 4 has detected the path failure is completed, and the control is shifted to the conventional path switching process (Step S505).

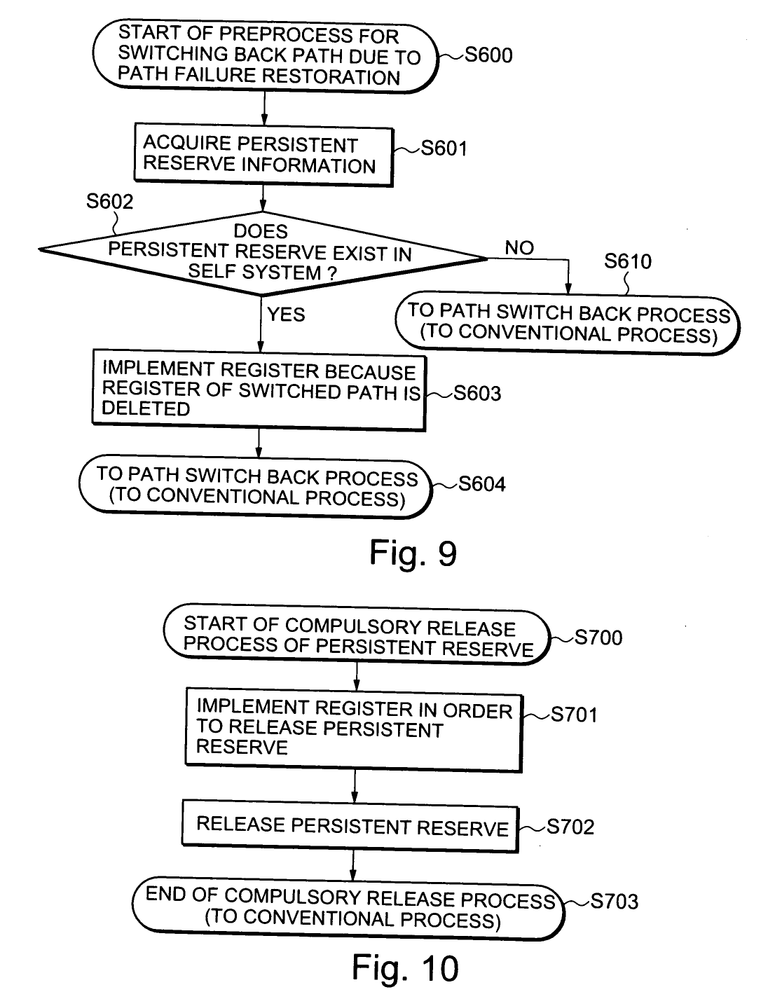

FIG. 9 is an exemplary flowchart showing a preprocess for integrating the restored path into path redundancy driver 4 as the normal path when the path, from which the path failure has been detected, is restored to a normal state due to the replacement of parts. Hereinafter, a description will be given mainly with reference to that drawing.

First, with respect to the persistent reserve information related to the logical disks at the present moment, the I/O request of the persistent reserve-in—read keys service and the persistent reserve-in—read reservation service is generated and then issued to downstream driver 5, to thereby acquire information from the disk array subsystem 10 (Step S601).

In Step S602, it is determined whether the reserve due to the persistent reserve has been implemented by host computer 1 of the path redundancy driver, or not, with reference to the information that has been acquired in Step S601. When the reserve has been implemented by host computer 1 of the path redundancy driver (e.g., a “YES” in Step S602), the control is shifted to Step 603. When the reserve has not been implemented by host computer 1 of the path redundancy driver (e.g., a “NO” in Step S602), the control is shifted to a conventional path switch-back process (Step S610).

In Step S603, there is the possibility that the register information for using the persistent reserve has been deleted from the path from which the path failure has been detected in advance (HBA 6 in this exemplary embodiment). As a result, the I/O request of the persistent reserve-out—register service which designates 8 bytes of the world wide port name of HBA 6 as the service action reservation key and designates zero as the reservation key again is generated, and then issued to downstream driver 5. Through the above processing, the persistent reserve can be also used from the path of HBA 6. When the middleware and the software use the reserve, the I/O access using a plurality of initiators can be conducted.

With the above operation, when the path from which the path failure has been detected is restored to the normal state due to the replacement of parts, the preprocess for integrating the restored path into path redundancy driver 4 as the normal path is completed, and the control is shifted to the conventional path switching process (Step S604).

In the processing of FIGS. 4 to 9, the substitution of the persistent reserve-in command and the persistent reserve-out command, the issuance to the disk array subsystem 10, and the management and control thereof with respect to the I/O request of the reserve, the release, or the reset which has been received from upstream driver 3, are concealed (e.g., transparent to the user and/or system) and processed within path redundancy driver 4. For that reason, it is unnecessary to modify the middleware or the software which uses upstream driver 3, downstream driver 5, and the reserve.

The I/O request of the reserve, the release, or the reset is mainly used in order that the middleware and the software exclusively control the logical disks. The I/O request is used at the time of starting the processing of the middleware or the software, or used for a given time interval during the operation of the middleware or the software, and not always used. Thus, the I/O request of the reserve, the release, and the reset does not affect the normal I/O request (for example, read data transfer I/O, and write data transfer I/O).

FIG. 10 is an exemplary flowchart showing a process for compulsorily releasing the persistent reserve. Hereinafter, a description will be given mainly with reference to that drawing.

In the persistent reserve-out—reserve service, a power supply of the disk array subsystem is turned off, and the reserve state before the power supply was turned off is continuously held even after the power supply is subsequently turned on depending on the parameter designation of the command. Thus, there is the possibility that the reserve may not be released by the persistent reserve, when a contradiction occurs in the reserve management while the reserve is being used or controlled by the middleware or the software. Taking the above into consideration, means for compulsorily releasing the reserve state due to the persistent reserve and the associated information is disposed in the path redundancy driver 4.

In Step S701, the I/O request of the persistent reserve-out—register and ignore existing key service which designates 8 bytes of the world wide port name of any HBA (HBA 6 in this exemplary embodiment) of HBA 6 and HBA 7 as the reservation key is generated with respect to the intended logical disks, and then issued to downstream driver 5.

Subsequently, in Step S702, the I/O request of the persistent reserve-out—clear service which designates 8 bytes of the world wide port name of HBA6 which has issued the persistent reserve-out—register and ignore existing key service in Step S701 as the reservation key is generated with respect to the intended logical disks, and then issued to downstream driver 5.

With the above operation, the processing when the path redundancy driver 4 receives the I/O request of the reserve compulsory release is completed, and the control is shifted to the conventional process (Step S703).

Through the above processing, it is possible to release all of the reserve state and the associated information due to the persistent reserve-out—reserve service and the persistent reserve output—register service with respect to the intended logical disks.

As one example, the following is a procedure for compulsorily releasing the persistent reserve when a contradiction occurs in the reserve management while the reserve is being used or controlled by the middleware or the software.
(1) Shut down (turn off a power) OS in all of nodes (host computers).
(2) Start (turn on the power) OS in only one arbitrary node.
(3) Change the setting of parameters so as not to automatically start the service program of the cluster software and the driver at the time of starting OS.
(4) Restart (power off to power on) OS.
(5) Execute a persistent reserve compulsory release command through a user interface that operates the path redundancy driver.
(6) Return the service program of the cluster software that has been changed in the above item (3) and the parameters of the driver to the original.
(7) Shut down OS.
(8) Start OS in all of the nodes and restart the cluster system.

Hereinafter, the exemplary advantages of the present invention will be described in detail. One exemplary advantage resides in that even when the middleware or the software uses the reserve with respect to the logical disks, the load dispersion function of the I/O path using a plurality of initiators can be positively utilized by the path redundancy driver, thereby improving the access performance.

That is, for example, the reserve state is established between a host bus adaptor (initiator) that has issued the reserve command and a disk (target). In this situation, even if another host bus adaptor reads or writes the disk that has been reserved from the host bus adaptor, an error occurs, and the read/write fails. For that reason, when using the reserve command, even if two host bus adaptors are equipped in the host computer, and the respective host bus adaptors are connected to the disk array subsystem by cables to provide two data transfer paths, the paths that can be used for data transfer is limited to one path. The present invention may solve the exemplary problem above and is capable of effectively utilizing a plurality of data transfer paths.

One exemplary advantage resides in that the substitution of the persistent reserve-in (SCSI-3) command and the persistent reserve-out (SCSI-3) command, the issuance to the disk array subsystem, and the management and control of those operation with respect to the I/O request of the reserve, the release, and the reset which are used by the middleware or the application with respect to the logical disks are concealed (transparent) and processed within the path redundancy driver. As a result, it may be unnecessary to modify the upstream driver, the downstream driver, the middleware, and the application.

The reason is stated below. For example, the path redundancy driver is mounted within an Operating System (OS) kernel as a filter driver. The filter driver compensates functions that are not provided in an OS standard driver. Also, the path redundancy driver has the permeability as indicated by the name “filter”, and since all functions other than the functions to be compensated, pass directly through the filter driver, it may be unnecessary to change the function in the upper and lower driver and middleware between which the filter driver is interposed. In addition, the application that operates at a user mode does not find (detect) the existence of the filter driver. As a result, it may be unnecessary to modify the application.

One exemplary advantage resides in that the filter driver affects the I/O request of the reserve, the release, or the reset which is used by the middleware or the application with respect to the logical disks, and does not affect other I/O requests.

That is, as described in the exemplary advantage above, the filter driver aims to compensate the functions which may not be provided by the OS standard driver. For that reason, the OS standard driver may normally process the functions except for the operation and effects which are functionally enhanced by the path redundancy driver (filter driver).

One exemplary advantage resides in that there is provided means for compulsorily releasing the persistent reserve when a contradiction occurs in the reserve management while the reserve is being used or controlled by the middleware or the software. As a result, the contradiction of the reserve management may be eliminated and may be restored to a normal state.

That is, for example, the reserve state of the disk due to the reserve command is canceled by the power off of the host computer (e.g., that is equipped with a host bus adaptor which has issued the reserve command), the power off of the disk device, or reset (LUN reset, target reset, bus reset) under the specification. Even when a contradiction occurs in the management of the reserve state due to the trouble (fault) of the middleware or the software while the reserve is being used or controlled by the middleware or the software, the reserve state may be released by the power off of the host computer or the disk device, to thereby enable restart.

On the other hand, the persistent reserve command can make a designation of not releasing the reserve state even in the power off state of the host computer, the power off state of the disk device, or the reset (LUN reset, target reset, bus reset). In this case, when a contradiction occurs in the management of the reserve state due to the trouble of the middleware, the software, or the path redundancy driver, the reserve state cannot be easily released. Thus, the reserve state must be released by a specific maintenance command through a maintainer or a development engineer of the disk array device. As a result, it is time-consuming for the task of a customer of the disk array device to be restarted, and the customer suffers from an extensive damage. Under the circumstances, the compulsory releasing means is disposed in advance to prevent and solve the above unexpected situation.

Hereinafter, another exemplary embodiment will be described.

In FIG. 2, host computer 1 that is equipped with two HBAs including HBA 6 and HBA 7 is shown as a structural example. The number of HBAs is limited by the type of OS, the OS standard driver, or the specification of the hardware of host computer 1, but the number of HBAs is not limited by the path redundancy driver 4.

In FIG. 2, disk array subsystem 10 that is equipped with two controllers including controllers 11 and 12 is shown as a structural example, but the number of controllers is not limited.

In FIG. 2, disk array subsystem 10 having controllers 11 and 12 equipped with host connection ports 16 and 17 one by one is shown as a structural element, but the number of host connection ports which are mounted on the controllers is not limited.

In FIG. 2, the structure in which HBAs 6 and 7 are connected directly to controllers 11 and 12 by host interface cables 20 and 21 is shown as a structural example, but as shown in FIG. 3, the switches or the hubs may be interposed between the HBA and the controllers.

In FIG. 2, the structure in which only one host computer is connected to disk array subsystem 10 is shown as a structural example, but as shown in FIG. 3, the number of host computers to be connected is not limited.

In FIG. 2, the structure in which the logical disks are loaded within disk array subsystem 10 is shown as a structural element. However, the logical disks may be structured by external disks such as JBOD (“just a bunch of disks”) which are connected to disk array subsystem 10.

The number of disk array subsystems which are connected to the host computers shown in FIGS. 2 and 3 is not limited.

Further, the number of logical disks 13 to 15 which are structured within disk array subsystem 10 shown in FIG. 2 is not limited.

Also, the number of inner paths 18 and 19 within disk array subsystem 10 shown in FIG. 2 is not limited.

Further, FIG. 3 is a structural example of a two-node cluster, but the number of nodes that constitute the cluster is not limited.

In this exemplary embodiment, the disk array subsystem is exemplified, but the present invention is not limited to only the disk array subsystem.

In this exemplary embodiment, 8 bytes of the world wide port name of HBA are used as the reservation key of the persistent reserve input command and the persistent reserve output command. However, the present invention is not limited to 8 bytes, but may be any values if the values are unique.

In this exemplary embodiment, the structure in which the disk array subsystem has the function of processing the persistent reserve-in command and the persistent reserve-out command is described as an example. Alternatively, it is possible that vendor-specific commands are equipped in the disk array subsystem, and one vendor-specific command or a combination of vendor-specific commands is realized.

While this invention has been described with reference to exemplary embodiments, this description is not intended as limiting. Various modifications of the illustrative embodiments, as well as other embodiments of the invention, will be apparent to persons skilled in the art upon taking description as a whole. It is, therefore, contemplated that the appended claims will cover any such modifications or embodiments as fall within the true scope of the invention.

Further, the inventor's intent is to encompass all equivalents of all the elements of the claimed invention even if the claims are amended during prosecution.

This application is based on Japanese Patent Application No. 2005-213468 filed on Jul. 22, 2005 and including specification, claims, drawings and summary. The disclosure of the above Japanese Patent Application is incorporated herein by reference in its entirety.

What is claimed is:

1. A path control device that controls first and second paths for accessing a peripheral subsystem, comprising:
a command substituting unit that substitutes a first reserve command that allows an access through said first path, with a second reserve command that allows accesses through both of said first path and said second path.

2. The path control device according to claim 1, further comprising:
a command acquiring unit that acquires said first reserve command; and
a command issuing unit that issues said second reserve command to said peripheral subsystem.

3. The path control device according to claim 1, wherein said second reserve command includes information related to said first path.

4. The path control device according to claim 2, wherein said command acquiring unit includes a function of acquiring at least one command of:
a release command that releases a reserve of said second path;
a reset command that cancels said reserve of said second path; and
a compulsory release command that compulsorily releases said reserve of said second path.

5. The path control device according to claim 4, wherein said command substituting unit substitutes said at least one command of said release command, said reset command and said compulsory command by a command that denies an access through only said second path,
wherein said command issuing unit issues said command.

6. The path control device according to claim 4, wherein said at least one command includes information related to said second path.

7. A system, comprising:
a host computer that includes said path control device according to claim 1; and
said peripheral subsystem according to claim 1.

8. The system according to claim 7, wherein said peripheral subsystem uses an SCSI (Small Computer System Interface) protocol.

9. The system according to claim 7, wherein said peripheral subsystem includes a disk array subsystem.

10. A cluster, comprising:
host computers, each of said host computers including said path control device according to claim 1.

11. A cluster system, comprising:
said cluster according to claim 10;
said peripheral subsystem; and
a switch that connects one of said host computers to said peripheral subsystem with respect to said first path of said each host computer.

12. A method of controlling first and second paths for accessing a peripheral subsystem, comprising:
substituting a first reserve command that allows an access through said first path by a second reserve command that allows accesses through both of said first path and said second path.

13. The method according to claim 12, further comprising:
acquiring said first reserve command; and
issuing said second reserve command to said peripheral subsystem.

14. The method according to claim 12, wherein said second reserve command includes information related to said first path.

15. The method according to claim 13, further comprising:
acquiring at least one of:
a release command that releases a reserve of said second path;
a reset command that cancels said reserve of said second path; and
a compulsory release command that compulsorily releases said reserve of said second path.

16. The method according to claim 15, further comprising:
substituting said at least one command of said release command, said reset command and said compulsory command by a command that denies an access only through said second path; and
issuing said command.

17. The method according to claim 16, wherein said at least one command includes information related to said second path.

18. A computer readable medium embodying a program, said program causing a path control device to perform the method of claim 12.
